(19) United States
(12) Patent Application Publication
(10) Pub. No.: US 2024/0182312 A1
(43) Pub. Date: Jun. 6, 2024

(54) NEW SILICA, PROCESS FOR ITS PREPARATION AND ITS USES

(71) Applicant: RHODIA OPERATIONS, Lyon (FR)

(72) Inventors: Cédric Feral-Martin, Emerainville (FR); Pascaline Lauriol-Garbey, Saint-Cyr-Au-Mont-D'or (FR); Caroline Fayolle, Lyon (FR); Frédéric Colbeau-Justin, Leuville-sur-Orge (FR)

(73) Assignee: RHODIA OPERATIONS, Lyon (FR)

(21) Appl. No.: 18/553,723

(22) PCT Filed: Apr. 1, 2022
(86) PCT No.: PCT/EP2022/058812

§ 371 Date: Oct. 2, 2023

(30) Foreign Application Priority Data
Apr. 2, 2021 (EP) 21305429.9

(51) Int. Cl. C01B 33/18; B29D 30/00; C08K 3/36

(52) U.S. Cl. CPC C01B 33/18; B29D 30/00; C08K 3/36; C01P 2004/51; C01P 2006/10; C01P 2006/12; C01P 2006/22; C08K 2201/003; C08K 2201/006

(57) ABSTRACT

A precipitated silica characterised by low silanol ratio. The precipitated silica is in particularly suitable for use as filler in elastomeric mixtures.

### CROSS REFERENCE TO A RELATED APPLICATION

This application claims priority from European application Nr 21305429.9 filed on 2 Apr. 2021, the whole content of this application being incorporated herein by reference for all purposes.

### TECHNICAL FIELD

The present invention relates to a new silica, to a process for the preparation of said silica and to its applications.

### BACKGROUND ART

Silica has long been used as reinforcing filler in polymeric materials and, in particular, in elastomers. It has also been widely used in oral care compositions (toothpaste) were it can act as a thickener (promoting the formation of a gel by water absorption).

It has now been found that the heat treatment (calcination) of silica, in particular precipitated silica, improves the use of said precipitated silica in polymeric compositions. It also improves the use of said precipitated silica in oral care compositions.

It has namely been found that the silica according to the present invention is easier to mix with elastomers allowing an improved process for the preparation of elastomeric compositions having well dispersed silica. The silica according to the invention also has a low water uptake and a low density of silanol functions which influences its reactivity in elastomeric formulations. It also gives improved oral care compositions.

More precisely, it has been found that the heat treatment of silica, especially in its final form (like micro beads) modifies its surface reactivity towards silanes and elastomers and impacts the adsorption of the other ingredients of the formula (accelerators for instance). It also modifies its surface reactivity with the other ingredients of oral care compositions.

### DESCRIPTION OF INVENTION

Therefore, the present invention concerns a precipitated silica characterized by:
a CTAB surface area from above 45 to 350 m²/g; and
a silanol ratio T_{SiOH} from 0.1 to 2.5 mmolOH/g.

A first embodiment of the invention relates to a precipitated silica characterized by:
a CTAB surface area from 100 to 350 m²/g; and
a silanol ratio T_{SiOH} from 0.1 to 2.5 mmolOH/g.

A second embodiment of the invention relates to a precipitated silica characterized by:
a CTAB surface area from above 45 to below 100 m²/g; and
a silanol ratio T_{SiOH} from 0.1 to 2.5 mmolOH/g.

The expression “silica” is used herein to refer to silicon dioxide, SiO₂. The term “silica” is used throughout the text to refer to precipitated silica. The expression “precipitated silica” is used to refer to a synthetic amorphous silica obtained by a process wherein a silicate is reacted with an acid causing the precipitation of SiO₂.

The inventive silica is characterized by a silanol ratio from 0.1 to 2.5 mmolOH/g. Preferably, this ratio is of at least 0.5, more preferably of at least 0.8 mmolOH/g. Preferably it is from 0.5 to 2.5, more preferably from 0.8 to 2.5 mmolOH/g

The silanol ratio (mmol/g) or T_{SiOH} is defined by: T_{SiOH}=ΔW*2*1000/(18.015*100)=1.11*ΔW wherein ΔW (%) is the loss of mass (%) between 200° C. and 800° C. measured by ATD-ATG, preferably as detailed in the Examples.

The inventive silica generally comprises a number of OH groups per surface area, expressed as number of OH/nm², which is equal to or greater than 2 OH/nm², preferably than 4 OH/nm². The number of OH groups per surface area is generally equal to or lower than 11 OH/nm², preferably than 10 OH/nm². The inventive silica is advantageously characterized by a number of OH groups per surface area of 2 to 11 OH/nm².

The determination of the silanol ratio and of the number of OH groups per surface area is determined using the ATD-ATG technique detailed hereafter.

In a first embodiment of the invention, the CTAB surface area is at least 100 m²/g, typically at least 120 m²/g. The CTAB surface area may be greater than 150 m²/g. In this embodiment, the CTAB surface area does not exceed 350 m²/g, the CTAB surface area is preferably lower than or equal to 300 m²/g, even lower than or equal to 250 m²/g, and even more preferably equal to or below 200 m²/g. In this first embodiment, the CTAB surface area is preferably from 120 to 300 m²/g, more preferably from 150 to 250 m²/g.

The CTAB surface area is a measure of the external specific surface area as determined by measuring the quantity of N-hexadecyl-N,N,N-trimethylammonium bromide adsorbed on the silica surface at a given pH. The CTAB surface area can be determined according to the standard NF ISO 5794-1, Appendix G (June 2010).

The BET surface area S_{BET} of the inventive silica is not particularly limited.

The BET surface area is determined according to the Brunauer-Emmett-Teller method described in The Journal of the American Chemical Society, Vol. 60, page 309, February 1938, and corresponding to the standard NF ISO 5794-1, Appendix D (June 2010).

The inventive silica generally has a ratio BET/CTAB of from 0.8 to 1.6, preferably from 0.9 to 1.3, even more preferably from 1.0 to 1.2.

A further preferred characteristic of the silica particulates is related to their specific shape and size, namely: the silica of the invention preferably comprises spheroidal globules (micro pearls) having a mean diameter (measured by SEM) of at least 80 μm. More particularly, this mean diameter may be larger than 150 μm and preferably ranges from 200 to 300 μm. Preferably, the silica of the invention consists essentially of such micro pearls meaning that generally 85% in weight of the silica particulates are micro pearls, preferably at least 90%, even more preferably at least 95% are such micro pearls.

Such micro pearls generally comprise aggregates (i.e. agglomerations of small particles which are chemically bonded to each other) having a median particle size d50, measured by centrifugal sedimentation, between 80 and 120 nm, preferably between 90 and 110 nm.

A further object of the invention is a process for the preparation of the inventive precipitated silica, said process comprising the steps of:
providing a starting precipitated silica, hereinafter defined as the “Starting Silica”; and
submitting said starting precipitated silica to a thermal treatment at a temperature of 300 to 600° C.

It has namely been found that at temperatures below 300° C., there is no significant effect and that at temperatures above 600° C., the silica structure is degraded leading to problems in terms of dispersion.

The Starting Silica may be in any form, such as a powder, granules, or substantially spherical beads, the latter being preferred and even more preferred are micro pearls (spheroidal globules), preferably as those described above. It has to be understood that this Starting Silica is a solid which has been obtained by precipitating silica, generally using a source of silicate (e.g. sodium silicate) and an acid (e.g. sulphuric acid), in an aqueous medium and by separating the so obtained solid (precipitated silica) from the aqueous phase in which it is suspended, and generally drying it afterwards e.g. by spray drying.

The Starting Silica is generally characterised by a silanol ratio above 2.5.

Additionally or alternatively, the Starting Silica is generally characterised by a number of OH groups per surface area higher than 12 OH/nm², for instance of about 13 OH/nm² or higher.

The thermal treatment of the invention is a calcination i.e. the heating a solid chemical compound (i.e. the Starting Silica) to high temperatures (i.e. 300 to 600° C.) while staying below its melting point, in a gaseous or inert atmosphere. Calcination in the presence of air gives good results in the frame of the invention. The thermal treatment (calcination) may be carried out using any suitable equipment. Non-limiting examples of suitable equipment for the thermal treatment are for instance a rotating oven or a muffle furnace.

In a further embodiment, the process for the preparation of the modified silica comprises the steps of:
heating the Starting Silica to a temperature of 300 to 600° C.;
holding said Starting Silica at a temperature of 300 to 600° C. for 1 to 150 minutes; and
cooling the resulting precipitated silica.

The thermal treatment is preferably performed at a temperature of 300 to 550° C., more preferably at a temperature of 350 to 500° C.

The duration of the thermal treatment is adjusted so that the silanol ratio is reduced from its initial value to a value of at most 2.5 mmolOH/g. It is generally from 1 to 180 minutes. The precipitated silica is preferably held at the thermal treating temperature for 30 to 150 minutes, preferably for 30 to 120 minutes.

Any silica may be used as Starting Silica in the inventive process. Mention may be made for instance of the following commercially available precipitated silicas: Zeosil© 1165MP, Zeosil© 1115MP, Zeosil© Premium 200MP, Zeosil© 195HR, Zeosil® 165GR, Zeosil® 115GR, Zeosil© HRS 1200MP, Zeosil©195GR, Zeosil©185GR, Zeosil©175GR, Zeosil©125GR (all commercially available from Solvay), Ultrasil® 5000GR, Ultrasil® 7000GR, Ultrasil® 9000GR, Ultrasil© VN3GR, Hi-Sil® EZ 160G-D, Hi-Sil® EZ 150G, Hi-Sil® 190G, Hi-Sil® 200G-D, Hi-Sil® HDP-320G, Hi-Sil® 255CG-D, Zeopol® 8755LS, Zeopol® 8745, Newsil© 115GR, Newsil© 2000MP, Tokusil® 315. Mention can also be made of silica doped with a metal, for instance Al, Zr, B, Ga, Sc, Y, Ti, Zr, Hf, Zn, Fe, Cu.

Notable, non-limiting examples of suitable processes for the preparation of precipitated silica that may be used as Starting Silica in the inventive process are disclosed for instance in EP396450A, EP520862A, EP647591A, EP670813A, EP670814A, EP901986A, EP762992A, EP762993A, EP917519A, EP983966A, EP1355856A, WO03/016215, WO2009/112458, WO2011/117400, WO2018/202752, WO2018/202755, WO2018/202756, WO2020/094714.

The inventive silica according to the present invention or obtained by the process according to the invention described above can be used in numerous applications.

The modified silica of the invention can be used in particular as filler for polymer compositions and in particular in elastomeric compositions.

The polymer compositions in which it can be employed, in particular as reinforcing filler, are generally based on one or more polymers or copolymers, in particular on one or more elastomers, preferably exhibiting at least one glass transition temperature of between −150° C. and +300° C., for example between −150° C. and +20° C.

The expression “copolymer” is used herein to refer to polymers comprising recurring units deriving from at least two monomeric units of different nature.

Mention may in particular be made, as possible polymers, of diene polymers and copolymers, in particular diene elastomers.

For example, use may be made of polymers or copolymers deriving from aliphatic or aromatic monomers, comprising at least one unsaturation (such as, in particular, ethylene, propylene, butadiene, isoprene, styrene, acrylonitrile, isobutylene or vinyl acetate), polybutyl acrylate, or their mixtures; mention may also be made of functionalized elastomers, that is elastomers functionalized by chemical groups positioned along the macromolecular chain and/or at one or more of its ends (for example by functional groups capable of reacting with the surface of the silica), and halogenated polymers. Mention may be made of polyamides, ethylene homo- and copolymers, propylene homo- and copolymers.

The polymer (copolymer) can be a bulk polymer (copolymer), a polymer (copolymer) latex or else a solution of polymer (copolymer) in water or in any other appropriate dispersing liquid.

Among diene elastomers mention may be made, for example, of polybutadienes (BRs or butadiene rubbers), polyisoprenes (IRs or isoprene rubbers), butadiene copolymers, isoprene copolymers, or their mixtures, and in particular styrene/butadiene copolymers (SBRs, in particular ESBRs (emulsion) or SSBRs (solution)), isoprene/butadiene copolymers (BIRs), isoprene/styrene copolymers (SIRs), isoprene/butadiene/styrene copolymers (SBIRs), ethylene/propylene/diene terpolymers (EPDMs). Good results are obtained with SSBRs, preferably in mixture with BRs.

Mention may also be made of natural rubber (NR) and epoxidized natural rubber (ENR). Especially good results are obtained with NR namely because the processing of this kind of elastomer involves high shear rates.

The polymer compositions can be vulcanized with sulfur or crosslinked, in particular with peroxides or other crosslinking systems (for example diamines or phenolic resins).

In general, the polymer compositions additionally comprise at least one (silica/polymer) coupling agent and/or at least one covering agent; they can also comprise, inter alia, an antioxidant.

Non-limiting examples of suitable coupling agents are for instance “symmetrical” or “unsymmetrical” silane polysulfides; mention may more particularly be made of bis((C1-C₄)alkoxyl(C1-C₄)alkylsilyl(C1-C₄)alkyl) polysulfides (in particular disulfides, trisulfides or tetrasulfides), such as, for example, bis(3-(trimethoxysilyl)propyl) polysulfides or bis(3-(triethoxysilyl)propyl) polysulfides, such as triethoxysilylpropyl tetrasulfide. Mention may also be made of monoethoxydimethylsilylpropyl tetrasulfide. Mention may also be made of silanes comprising masked or free thiol functional groups.

The coupling agent can be grafted beforehand to the polymer. It can also be employed in the free state or grafted at the surface of the silica. It is the same for the optional covering agent.

The proportion by weight of the inventive silica in the polymer composition can vary within a fairly wide range. It normally represents from 10% to 200% by weight in relation to the amount of the polymer(s) (i.e. 10-200 phr or per hundred rubber). In particular, it amounts from 20% to 150% by weight in relation to the amount of the polymer(s) (i.e. 20-150 phr) in case silica is used as major filler, and from 10% to 50% by weight of the amount of the polymer(s) (i.e. 10-50 phr) in case it is used in combination with a substantial amount of carbon black (for instance more than 10 phr).

The inventive silica according to the invention can advantageously constitute all of the reinforcing inorganic filler and even all of the reinforcing filler of the polymer composition.

However, the inventive silica according to the invention can optionally be combined with at least one other reinforcing filler, such as, in particular, a treated precipitated silica (for example, a precipitated silica “doped” using a cation, such as aluminum); another reinforcing inorganic filler, such as, for example, alumina, indeed even a reinforcing organic filler, in particular carbon black (optionally covered with an inorganic layer, for example of silica).

The present invention also concerns polymer compositions as described above i.e. comprising the inventive silica as described above as well.

These polymer compositions may be used for the manufacture of at least part of a number of articles. Non-limiting examples of finished articles comprising at least one of the polymer compositions described above are for instance of footwear soles, floor coverings, gas barriers, flame-retardant materials and also engineering components, such as rollers for cableways, seals for domestic electrical appliances, seals for liquid or gas pipes, braking system seals, pipes (flexible), sheathings (in particular cable sheathings), cables, engine supports, battery separators, conveyor belts, transmission belts or, preferably, tires, in particular tire treads (especially for light vehicles or for heavy-goods vehicles, e.g. trucks).

The precipitated silica of the invention can also be used in oral care formulations as abrasive and/or thickening agent, in particular in oral care compositions comprising a peroxide-releasing compound.

The expression “peroxide-releasing compound” is used herein to refer to hydrogen peroxide, peroxides as well as any compound capable to release hydrogen peroxide under the conditions of use in an oral care application. Notable, non-limiting examples of peroxide-releasing compounds are include hydroperoxides, hydrogen peroxide, peroxides of alkali and alkaline earth metals, organic peroxy compounds, peroxy acids, pharmaceutically-acceptable salts thereof, and mixtures thereof. Peroxides of alkali and alkaline earth metals include lithium peroxide, potassium peroxide, sodium peroxide, magnesium peroxide, calcium peroxide, barium peroxide, and mixtures thereof. Organic peroxy compounds include urea peroxide, glyceryl hydrogen peroxide, alkyl hydrogen peroxides, dialkyl peroxides, alkyl peroxy acids, peroxy esters, diacyl peroxides, benzoyl peroxide, and monoperoxyphthalate, and mixtures thereof. Peroxy acids and their salts include organic peroxy acids such as alkyl peroxy acids, and monoperoxyphthalate and mixtures thereof, as well as inorganic peroxy acid salts such as and perborate salts of alkali and alkaline earth metals such as lithium, potassium, sodium, magnesium, calcium and barium, and mixtures thereof. Preferred solid peroxides are sodium perborate, urea peroxide, and mixtures thereof.

The peroxide-releasing compound may be bound to a polymer such as polymers of poly(vinylpyrrolidone), polyacrylates, polymethacrylates.

The oral care composition typically contains from 1 to 50%, typically from 3 to 40%, preferably from 3 to 20% by weight of the peroxide-releasing compound.

The oral care composition contains from 3 to 60%, typically from 5 to 50%, preferably from 5 to 30% by weight of the inventive silica.

The composition of the invention may include other ingredients commonly used in oral care applications, in particular other water-insoluble inorganic abrasive agents, thickening agents, moisturizers, surfactants, and the like. Other abrasive agents which may be mentioned in particular are calcium carbonate, hydrated alumina, bentonite, aluminium silicate, zirconium silicate and sodium, potassium, calcium and magnesium metaphosphates and phosphates.

Among thickening agents mention may be made in particular of xanthan gum, guar gum, carrageenans, cellulose derivatives and alginates, in a quantity that can range up to 5% by weight of the composition.

Among the moisturizers mention may be made, for example, of glycerol, sorbitol, polyethylene glycols, polypropylene glycols and xylitol, in a quantity of the order of 2 to 85%, preferably of the order of 10 to 70% of the weight of composition, expressed on dry basis.

The inventive composition may additionally comprise surface-active agents, detergent agents, colorants, bactericides, fluorine derivatives, opacifiers, sweeteners, antitartar and antiplaque agents, sodium bicarbonate, antiseptics, enzymes, etc.

In a preferred embodiment of the invention, the composition further comprises antibacterial agent. Notable non-limiting examples of suitable antibacterial agents are chlorhexidine and chlorhexidine salts, such as bigluconate or diacetate, triclosan, cetylpyridinium chloride, benzalconium chloride and cetyltrimethylammonium bromide.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### Analytical Methods

The physicochemical properties of the inventive silica of the invention were determined using the methods described hereafter.

Determination of CTAB Surface Area CTAB surface area values were determined according to an internal method derived from standard NF ISO 5794-1, Appendix G.

### Determination of BET Surface Area

BET surface area S_{BET} was determined according to the Brunauer-Emmett-Teller method as detailed in standard NF ISO 5794-1, Appendix E (June 2010) with the following adjustments: the sample was pre-dried at 200° C.±10° C.; the partial pressure used for the measurement P/P⁰ was between 0.05 and 0.3.

### Silanol Ratio and Silanol Density Determination

The samples (either stored in a dry, controlled atmosphere, or subjected to a pre-conditioning of at least 2 h at 105° C. in order to remove any humidity uptake) were analyzed using ATD-ATG technique on Mettler's LF1100 thermobalance and a Tensor 27 Bruker spectrometer equipped with a gas cell, with the following program: Temperature rise from 25° C. to 1100° C. at 10° C./min, under air (60 mL/min), in Al₂O₃ crucible of 150 μL. The silanol density is directly related to the loss of mass between 200° C. and 800° C. The loss of mass (%) between 200° C. and 800° C. is identified as ΔW %.

The silanol ratio (mmol/g) is defined by:

T_{SiOH}=ΔW*2*1000/(18.015*100)=1.11*ΔW

Silanol density (OH/nm²) is calculated by:

D=T_{SiOH}*Na/10²1*S_{BET}=T_{SiOH}*602.2/S_{BET}

wherein Na: Avogadro's number

### Determination of the Particle Size Distribution and Particle Size by Centrifugal Sedimentation in a Disc Centrifuge (CPS)

Values of d50 are determined by centrifugal sedimentation in a disc centrifuge using a centrifugal photosedimentometer type “CPS DC 24000UHR”, marketed by CPS Instruments company. This instrument is equipped with an operating software supplied with the device (operating software version 11g).

Instruments used: for the measurement requirement, the following materials and products were used: Utrasound system: 1500 W generator type Sonics Vibracell VC1500NCX1500 equipped with 19 mm probe (Converters: CV154+ Boosters (Part No: BHNVC21)+19 mm Probe (Part No: 630-0208)).

Analytical balance with a precision of 0.1 mg (e.g. Mettler AE260); Syringes: 1.0 ml and 2.0 ml with 20 ga needles; high shape glass beaker of 50 mL (SCHOTT DURAN: 38 mm diameter, 78 mm high); magnetic stirrer with a stir bar of 2 cm; vessel for ice bath during sonication. Chemicals: deionized water; ethanol 96%; sucrose 99%; dodecane, all from Merck; PVC reference standard from CPS Instrument Inc.; the peak maximum of the reference standard used should be between 200 and 600 nm (e.g. 237 nm)

### Sedimentation in a Disc Centrifuge (CPS)

For the measurements, the following parameters were established. For the calibration standard parameters, the information of the PVC reference communicated by the suppler were used.

Sample Parameters

| | | |
|---|---|---|
| Max diameter | μm | 0.79 |
| Min diameter | μm | 0.02 |
| Particle density | g/ml | 2.11 |
| Particle refractive | | 1.46 |
| index | | |
| Particle absorption | K | 0.001 |
| Non sphericity | | 1 |
| factor | | |

Calibration Standard parameters

| | | |
|---|---|---|
| Peak diameter | nm | 237 |
| Half height peak | μm | 0.023 |
| width | | |
| Particle density | | 1.385 |

Fluid parameters

| | | |
|---|---|---|
| Fluid density | g/ml | 1.051 |
| Fluid refractive | | 1.3612 |
| index | | |
| Fluid viscosity | Cps* | 1.28 |

*cps = centipoise

### System Configuration

The measurement wavelength was set to 405 nm. The following runtime options parameters were established:

| Force baseline | Yes |
|---|---|
| Correct for Non-Stokes | No |
| Extra Software Noise Filtration | No |
| Baseline drift display | Show |
| Calibration method | External |
| Samples per calibration | 1 |

All the others options of the software are left as set by the manufacturer of the instrument.

### Preparation of the Disc Centrifuge

The centrifugal disc is rotated at 24000 rpm during 30 min. The density gradient of sucrose (CAS no 57-50-1) is prepared as follows:

In a 50 mL beaker, a 24% in weight aqueous solution of sucrose is prepared. In a 50 mL beaker, a 8% in weight aqueous solution of sucrose is prepared. Once these two solutions are homogenized separately, samples are taken from each solution using a 2 mL syringe which is injected into the rotating disc in the following order:
Sample 1: 1.8 mL of the 24 wt % solution
Sample 2: 1.6 mL of the 24 wt % solution+0.2 mL of the 8 wt % solution
Sample 3: 1.4 mL of the 24 wt % solution+0.4 mL of the 8 wt % solution
Sample 4: 1.2 mL of the 24 wt % solution+0.6 mL of the 8 wt % solution
Sample 5: 1.0 mL of the 24 wt % solution+0.8 mL of the 8 wt % solution
Sample 6: 0.8 mL of the 24 wt % solution+1.0 mL of the 8 wt % solution
Sample 7: 0.6 mL of the 24 wt % solution+1.2 mL of the 8 wt % solution
Sample 8: 0.4 mL of the 24 wt % solution+1.4 mL of the 8 wt % solution
Sample 9: 0.2 mL of the 24 wt % solution+1.6 mL of the 8 wt % solution
Sample 10: 1.8 mL of the 8 wt % solution

Before each injection into the disk, the two solutions are homogenized in the syringe by aspiring about 0.2 mL of air followed by brief manual agitation for a few seconds, making sure not to lose any liquid.

These injections, the total volume of which is 18 mL, aim to create a density gradient useful for eliminating certain instabilities which may appear during the injection of the sample to be measured. To protect the density gradient from evaporation, we add 1 mL of dodecane in the rotating disc using a 2 mL syringe. The disc is then left in rotation at 24000 rpm for 60 min before any first measurement.

### Sample Preparation

3.2 g of silica in a 50 mL high shape glass beaker (SCHOTT DURAN: diameter 38 mm, height 78 mm) were weighed and 40 mL of deionized water were added to obtain a 8 wt % suspension of silica.

The suspension was stirred with a magnetic stirrer (minimum 20 s) before placing the beaker into a crystallizing dish filled with ice and cold water. The magnetic stirrer was removed and the crystallizing dish was placed under the ultrasonic probe placed at 1 cm from the bottom of the beaker. The ultrasonic probe was set to 56% of its maximum amplitude and was activated for 8 min. At the end of the sonication the beaker was placed again on the magnetic stirrer with a 2 cm magnetic stir bar stirring at minimum 500 rpm until after the sampling.

The ultrasonic probe should be in proper working conditions. The following checks have to be carried out and incase of negative results a new probe should be used: visual check of the physical integrity of the end of the probe (depth of roughness less than 2 mm measured with a fine caliper); the measured d50 of commercial silica Zeosil®1165MP should be 96 nm±3 nm.)

### Analysis

Before each samples was analysed, a calibration standard was recorded. In each case 0.1 mL of the PVC standard provided by CPS Instruments and whose characteristics were previously entered into the software was injected. It is important to start the measurement in the software simultaneously with this first injection of the PVC standard. The confirmation of the device has to be received before injecting 100 μL of the previously sonicated sample by making sure that the measurement is started simultaneously at the injection.

These injections were done with 2 clean syringes of 1 mL.

At the end of the measurement, which is reached at the end of the time necessary to sediment all the particles of smaller diameter (configured in the software at 0.02 μm), the ratio for each diameter class was obtained. The curve obtained is called aggregate size distribution.

Results: The D50 values are on the basis of distributions drawn in a linear scale. The integration of the particle size distribution function of the diameter allows obtaining a “cumulative” distribution, that is to say the total mass of particles between the minimum diameter and the diameter of interest. D50 is the diameter below and above which 50% of the population by mass is found. The d50 is called median size, that is diameter, of the silica aggregates.

### Example 1—Preparation of Modified Silicas

Modified precipitated silicas were prepared according to the following procedure: calcination in air of the starting silica in a muffle furnace while respecting the following protocol: temperature rise between 2 and 10°/min then a plateau at the desired temperature for 2 hours then natural cooling (approximately for 6-8 hours).

The characteristics of the starting silica (namely Zeosil® 1165MP and Premium SW) and the modified silica using them as starting silica (namely silica A to F for those base on Z1165MP and silica G to I for those based on Premium SW) are summarized in Table 1 below.

TABLE 1

| | Temper- | | | D50 | | Silanol |
|---|---|---|---|---|---|---|
| | ature | CTAB | BET | CPS | BET/ | number |
| Products | (° C.) | (m²/g) | (m²/g) | (nm) | CTAB | (mmolOH/g) |
| Z1165MP | / | 158 | 150 | 97 | 0.99 | 3.3 |
| Silica A | 250 | 157 | 148 | 95 | 0.94 | 3.1 |
| Silica B | 350 | 157 | 142 | 95 | 0.90 | 2.4 |
| Silica C | 400 | 156 | 148 | 96 | 0.95 | 2.0 |
| Silica D | 450 | 155 | 147 | 99 | 0.95 | 1.7 |
| Silica E | 500 | 153 | 138 | 99 | 0.90 | 1.4 |
| Silica F | 650 | 151 | 133 | 101 | 0.88 | 0.8 |
| Premium | / | 245 | 258 | 93 | 1.05 | 2.8 |
| SW | | | | | | |
| Silica G | 300 | 240 | 264 | 96 | 1.10 | 2.4 |
| Silica H | 400 | 245 | 261 | 99 | 1.09 | 1.7 |
| Silica I | 500 | 240 | 266 | 101 | 1.09 | 1.1 |

Table 1 shows that the morphology (particle size & BET) of the silicas is not significantly affected by calcination (except for Silica F which has been calcinated at 650° C.) while the silanol number (i.e. the silanol density) is.

### Example 2: Use of Silica in Elastomeric Compositions

### Materials

Silicas according to the invention were evaluated in a NR/BR matrix. The compositions, expressed as parts by weight per 100 parts of elastomers (phr), are described in Table 2 below. The amount of silica (in phr) are a bit higher for references silicas than for the corresponding calcinated silicas due to the lower water content of the calcined silicas; the amount of silica in phr was namely adjusted in function of the water content of the silicas in order to obtain the same amount of SiO2 in the compound.

TABLE 2

| | Z1165 MP | Silica E | PSW | Silica H | Silica I |
|---|---|---|---|---|---|
| NR (1) | 80 | 80 | 80 | 80 | 80 |
| BR(2) | 20 | 20 | 20 | 20 | 20 |
| Carbon | 5 | 5 | 5 | 5 | 5 |
| black (N121) | | | | | |
| Z1165MP | 58 | | | | |
| Silica E | | 55 | | | |
| Premium SW | | | 48 | | |
| Silica H | | | | 45 | |
| Silica I | | | | | 45 |
| TESPT (3) | 4.4 | 4.4 | 5.7 | 5.7 | 5.7 |
| Stearic acid | 2.5 | 2.5 | 2.5 | 2.5 | 2.5 |
| ZnO | 3 | 3 | 3 | 3 | 3 |
| 6-PPD (4) | 1.5 | 1.5 | 1.5 | 1.5 | 1.5 |
| TMQ (5) | 1 | 1 | 1 | 1 | 1 |
| Sulfur | 1.5 | 1.5 | 1.5 | 1.5 | 1.5 |
| CBS (6) | 1.9 | 1.9 | 1.9 | 1.9 | 1.9 |
| TBzTD (7) | 0.2 | 0.2 | 0.2 | 0.2 | 0.2 |

Natural rubber, SVR - CV60 from Weber&Schaer
(1) Butyl Rubber, Buna CB 25 from Lanxess
(2)Bis[3-(triethoxysilyl)propyl] Tetrasulfide, TESPT Luvomaxx, from Lehmann&Voss&Co
(3) N-(1,3-Dimethylbutyl)-N-phenyl-para-phenylenadiamine, Santoflex 6-PPD from Flexsys
(4) 1,2-dihydro-2,2,4-trimethylquinoline, Acetonanile TMQ from SMPC
(5) N-Cyclohexyl-2-benzothiazolesulfenamide, Rhenogran CBS-80 from Rhein Chemie
(6) Tetrabenzylthiuram disulfide, Rhenogran TBzTD-70 from Rhein Chemie

### Process for the Preparation of the Rubber Compositions

The preparation of the rubber compositions was carried out in two successive preparation phases: a first phase of high-temperature thermomechanical working, followed by a second phase of mechanical working at temperatures of less than 110° C. to introduce the vulcanization system.

The first phase was carried out using a mixing device, of internal mixer type, of Brabender brand (capacity of 380 mL). The initial temperature and the speed of the rotors were set so as to achieve mixture dropping temperatures of 160° C.

In a first pass of the first phase the elastomers and the reinforcing filler (introduction in instalments) were mixed with the coupling agent, the carbon black and the stearic acid. The duration was 4 min 30.

After cooling the mixture (temperature of less than 100° C.), a second pass made it possible to incorporate the zinc oxide and the protecting agents/antioxidants. The duration of this pass was 4 minutes.

After cooling the mixture (temperature of less than 100° C.), the vulcanization system (sulfur and accelerators, such as CBS) were added during the second phase. It was carried out on an open mill, preheated to 50° C. The duration of this phase was between 4 and 6 minutes

Each final mixture was subsequently calendered in the form of plates with a thickness of 2-3 mm.

### Properties of the Vulcanisates

The measurements were carried out after vulcanization at 150° C.

The measurements of the loss of mass by abrasion were performed according to the indications of NF ISO 4649. The value measured is a volume of loss of substance (in mm³) after abrasion wear; the smaller the value, the better the abrasion resistance.

The energy dissipation was measured. The values for the loss factor (tan 5) were recorded on vulcanized samples (cylindrical samples, section 95 mm² and 14 mm high). The sample was subjected to a pre-strain at 10% sinusoidal deformation, and dynamic solicitation of 4%. Measurements are performed at 60° C. and 10 Hz frequency on a Metravib VA 3000.

The results are summarized in Table 3 below

TABLE 3

| | Starting silica | | | | |
|---|---|---|---|---|---|
| property | Z1165 MP | Silica E | PSW | Silica H | Silica I |
| Abrasion loss | 80 | 71 | 82 | 69 | 71 |
| (mm³) | | | | | |
| tanδ 60° C. | 0.098 | 0.092 | 0.110 | 0.113 | 0.104 |

The calcinated silicas according to the invention hence allow better abrasion resistance of the compounds without negative impact on the rolling resistance (similar or better energy dissipation at 60° C.) compared to the starting (non calcinated) silicas.

### Example 3: Use of Silica in Elastomeric Compositions

### Materials

Silicas according to the invention were evaluated in a SBR/BR matrix. The compositions, expressed as parts by weight per 100 parts of elastomers (phr), are described in Table 4 below.

TABLE 4

| Composition | Silica E | Silica F |
|---|---|---|
| SBR (1) | 80 | 80 |
| BR (2) | 20 | 20 |
| Silica E | 90 | |
| Silica F | | 90 |
| TESPD (3) | 6.2 | 6.2 |
| Carbon black | 3.0 | 3.0 |
| TDAE oil (4) | 15 | 15 |
| Hydrocarbon resin (5) | 20 | 20 |
| stearic acid | 2.0 | 2.0 |
| 6-PPD (6) | 2.5 | 2.5 |
| ZnO | 1.2 | 1.2 |
| Sulfur | 1.7 | 1.7 |
| CBS (7) | 2.3 | 2.3 |
| DPG (8) | 1.7 | 1.7 |

(1) SBR: Solution SBR from JSR with 59% of vinyl units; 27% of styrene units; Tg of −28° C.;
(2) BR: Butyl Rubber Buna CB 25 from Lanxess
(3) TESPD: Bis[3-(triethoxysilyl)propyl]disulfide, Xiameter Z-6920 from Dow Corning
(4) TDAE oil, Vivatec 500 from Hansen & Rosenthal KG
(5) Hydrocarbon resin Sylvatraxx 4101 from Arizona Chemical
(6) 6PPD: N-(1,3-Dimethylbutyl)-N-phenyl-para-phenylenediamine, Santoflex 6-PPD from Flexsys
(7) CBS: N-Cyclohexyl-2-benzothiazolesulfenamide, Rhenogran CBS-80 from RheinChemie
(8) DPG: Diphenylguanidine, Rhenogran DPG-80 from RheinChemie

### Process for the Preparation of the Rubber Compositions

The preparation of the rubber compositions was carried out in two successive preparation phases: a first phase of high-temperature thermomechanical working, followed by a second phase of mechanical working at temperatures of less than 110° C. to introduce the vulcanization system. The first phase was carried out using a mixing device, of internal mixer type, of Brabender brand (capacity of 380 mL).

In a first pass of the first phase the elastomers and the reinforcing filler (introduction in instalments) were mixed with the coupling agent, the plasticizers, the stearic acid, the 6-PPD and the ZnO. The duration was 4 min 30 and the dropping temperature was about 160° C.

After cooling the mixture (temperature of less than 100° C.), the vulcanization system was added during the second phase. It was carried out on an open mill, preheated to 50° C. The duration of this phase was between 2 and 6 minutes. Each final mixture was subsequently calendered in the form of plaques with a thickness of 2-3 mm

### Properties of the Vulcanisates

The measurements were carried out after vulcanization at 160° C.

The Z value was measured, after crosslinking, according to the method described by S. Otto and al. in Kautschuk Gummi Kunststoffe, 58 Jahrgang, NR 7-8/2005 in accordance with ISO 11345.

The percentage “area not dispersed” is calculated using a camera observing the surface of the sample in a 30° incident light. The bright points are associated with the charge and the agglomerates, while dark points are associated with the rubber matrix. A digital processing transforms the image into a black and white image, and allows the determination of the percentage “area not dispersed”, as described by S. Otto in the document cited above. The higher the Z value, the better dispersion of the charge in the elastomeric matrix (a Z value of 100 corresponding to a perfect dispersion and a Z value of 0 corresponds to a very bad dispersion).

The calculation of the Z value is based on the percentage area in which the charge is not dispersed as measured by the machine DisperGrader® 1000 supplied with its operative mode and its operating software DisperData by the company Dynisco according to equation: Z=100−(percent area not dispersed)/0.35.

The results are summarized in Table 5 below

TABLE 5

| | Silica E | Silica F |
|---|---|---|
| Z-value | 86 | 59 |

The silica calcined at 650° C. shows a poor dispersion compared to the silica calcined at 500° C.

1. A precipitated silica having:
a CTAB surface area from above 45 to 350 m²/g; and
a silanol ratio T_{SiOH} from 0.1 to 2.5 mmol OH/g.

2. The precipitated silica according to claim 1 wherein the CTAB surface area is from 100 to 350 m²/g.

3. (canceled)

4. The precipitated silica of claim 1 which comprises micro pearls having a mean diameter of at least 80 μm.

5. (canceled)

6. A process for the preparation of the precipitated silica of claim 1, said process comprising the steps of:
providing a starting precipitated silica; and
submitting said starting precipitated silica to a thermal treatment at a temperature of 300 to 600° C.

7. The process of claim 6, wherein the starting precipitated silica comprises micro pearls.

8. The process of claim 6 comprising the steps of:
heating the starting precipitated silica to a temperature of 300 to 600° C.;
holding said starting precipitated silica at a temperature of 300 to 600° C. for 1 to 150 minutes to obtain a resulting precipitated silica; and
cooling the resulting precipitated silica.

9. (canceled)

10. (canceled)

11. (canceled)

12. (canceled)

13. A polymer composition comprising the precipitated silica of claim 1 and a diene elastomer.

14. (canceled)

15. A tire tread for light vehicles or for heavy-goods vehicles comprising the polymer composition according to claim 13.

16. The precipitated silica according to claim 1 of which the CTAB surface area ranges from above 45 to below 100 m²/g.

17. A method which comprises using the precipitated silica of claim 16 as an abrasive and/or thickening agent in an oral care composition comprising a peroxide-releasing compound.

18. The precipitated silica of claim 1 of which the silanol ratio T_{SiOH} is from 0.8 to 2.5 mmol OH/g.

19. The process of claim 6 wherein the thermal treatment is a calcination in air.

20. The process of claim 6 wherein the thermal treatment is carried out using a muffle furnace.

21. The process of claim 6 wherein the thermal treatment is a calcination in air and is carried out using a muffle furnace.

22. Precipitated silica micro pearls having a mean diameter of at least 80 μm, a CTAB surface area from above 45 to 350 m²/g and a silanol ratio T_{SiOH} from 0.1 to 2.5 mmol OH/g.

23. The precipitated silica micro pearls of claim 22 which comprise precipitated silica aggregates having a median particle size d50, measured by centrifugal sedimentation, between 80 and 120 nm.

24. The precipitated silica micro pearls of claim 22 of which the silanol ratio T_{SiOH} is from 0.8 to 2.5 mmolOH/g.

25. A process for the preparation of the precipitated silica micro pearls of claim 22, said process comprising the steps of:
providing a starting precipitated silica comprising micro pearls; and
submitting said starting precipitated silica to a thermal treatment at a temperature of 300 to 600° C.

26. The process of claim 25 wherein the thermal treatment is a calcination in air and is carried out using a muffle furnace.

27. A tire tread for light vehicles or for heavy-goods vehicles comprising a polymer composition comprising the precipitated silica micro pearls of claim 22 and a diene elastomer.
